(19) United States
(12) Patent Application Publication
(10) Pub. No.: US 2025/0147646 A1
(43) Pub. Date: May 8, 2025

(54) IMAGE MONITORING DEVICE AND METHOD CAPABLE OF ADAPTIVELY PLACING A PLURALITY OF IMAGES

(71) Applicant: HANWHA VISION CO., LTD., Seongnam-si (KR)

(72) Inventors: Chung Jin SON, Seongnam-si (KR); Hyun Ho KIM, Seongnam-si (KR); Ho Jung LEE, Seongnam-si (KR); Sang Yun LEE, Seongnam-si (KR)

(73) Assignee: HANWHA VISION CO., LTD., Seongnam-si (KR)

(21) Appl. No.: 19/012,109

(22) Filed: Jan. 7, 2025

Related U.S. Application Data
(63) Continuation of application No. PCT/KR2023/009837, filed on Jul. 11, 2023.

(30) Foreign Application Priority Data
Jul. 12, 2022 (KR) 10-2022-0085666

(51) Int. Cl. G06F 3/04842; G06F 3/04845; H04N 7/18

(52) U.S. Cl. CPC G06F 3/04842; G06F 3/04845; H04N 7/181

(57) ABSTRACT

An image monitoring device includes: a network interface; a user interface; an image decoder; and an image synthesizer configured to display a first image, that is decoded, on a screen, wherein the screen includes a plurality of unit cells, wherein the image synthesizer is further configured to, based on a second image being additionally selected via the user interface: display the first image and the second image together on the screen; and increase an amount of the plurality of unit cells by expanding the plurality of unit cells first in a horizontal row direction and then in a vertical column direction, based on a condition that a number of the plurality of unit cells in the horizontal row direction is greater than or equal to a number of the plurality of unit cells in the vertical column direction is always satisfied.

### CROSS-REFERENCE TO RELATED APPLICATIONS

This application is a bypass continuation application of International Application No. PCT/KR2023/009837, filed on Jul. 11, 2023, which claims priority to Korean Patent Application No. 10-2022-0085666, filed in the Korean Intellectual Property Office on Jul. 12, 2022, the disclosures of which are herein incorporated by reference in their entireties.

### BACKGROUND

### 1. Field

Embodiments of the present discourse relate to an image monitoring device and method capable of adaptively placing a plurality of images received from a plurality of camera devices.

### 2. Brief Description of Background Art

In general, a video surveillance system receives images from a plurality of camera devices and displays all or some of the received images on a screen of an image monitoring device, thereby providing a function of allowing a user to simultaneously monitor a plurality of images of interest (e.g., real-time images or stored images) which satisfy search conditions or in which an event has occurred.

However, various types of images are added to, or manipulations such as enlargement and movement are performed on, the screen displaying the images. At each such time, a plurality of images that should be displayed at the moment need to be displayed in an optimal layout, but there is no known systematic method for configuring the optimal layout. In the past, images were simply placed on the screen in the order in which they were added. However, this may cause various problems such as empty spaces being created or certain images being viewed too small.

In particular, when a special image having a special aspect ratio, such as a panorama or a hallway view, is displayed on the screen together with general images, the above problems may be further magnified.

Therefore, there is a need to develop a systematic way to optimally place images in the current situation regardless of the number of images selected, whether images with special aspect ratios are included, or whether manipulations (e.g., movement, enlargement, etc.) are performed on images already placed.

### SUMMARY

According to embodiments of the present disclosure, an image monitoring device is provided that is capable of providing high intuitiveness and visibility to a user despite various image allocations and editing in a device which displays a plurality of images on one screen.

According to embodiments of the present disclosure, an image monitoring device may be provided and include: a network interface configured to receive a plurality of images from a plurality of cameras through at least one channel; a user interface configured to allow a user to select at least a first image to be displayed on a screen from among the plurality of images that are received; an image decoder configured to decode the first image that is selected; and an image synthesizer configured to display the first image, that is decoded, on the screen, wherein the screen includes a plurality of unit cells, wherein the image synthesizer is further configured to, based on a second image being additionally selected via the user interface: display the first image and the second image together on the screen; and increase an amount of the plurality of unit cells by expanding the plurality of unit cells first in a horizontal row direction and then in a vertical column direction, based on a condition that a number of the plurality of unit cells in the horizontal row direction is greater than or equal to a number of the plurality of unit cells in the vertical column direction is always satisfied.

According to one or more embodiments of the present disclosure, the image synthesizer is further configured to place the first image and the second image on the screen such that a relative position of the first image does not change when the second image is placed.

According to one or more embodiments of the present disclosure, the plurality of unit cells have a same reference aspect ratio, and the image synthesizer is further configured to: place the first image in one unit cell from among the plurality of unit cells based on an aspect ratio of the first image being smaller than or equal to the reference aspect ratio; and place the first image across two or more unit cells from among the plurality of unit cells based on the aspect ratio of the first image being greater than the reference aspect ratio.

According to one or more embodiments of the present disclosure, the image synthesizer is further configured to, based on a third image being added after the first image is placed in the two or more unit cells: place, based on an aspect ratio of the third image being smaller than or equal to an aspect ratio of an empty area of the screen that is adjacent to the first image placed in the two or more unit cells, the third image in the empty area of the screen; and place, based on the aspect ratio of the third image being greater than the aspect ratio of the empty area, the third image in another unit cell that is spaced apart from the first image.

According to one or more embodiments of the present disclosure, the image synthesizer is further configured to determine in advance a number of the plurality of unit cells required for placing a plurality of selected images, and place the plurality of selected images in the number of the plurality of unit cells determined such that a number of empty unit cells among the plurality of unit cells is minimized.

According to one or more embodiments of the present disclosure, the image synthesizer is further configured to, based on a command to place the second image at a first position where the first image is already placed being input through the user interface, place the second image in a unit cell from among the plurality of unit cells that is at a second position next to the first position.

According to one or more embodiments of the present disclosure, the image synthesizer is further configured to, based on a command to move a specific image from among a plurality of displayed images on the screen being input through the user interface: place the specific image at a position at which an existing image is present; find an empty unit cell from among the plurality of unit cells by scanning the screen in a horizontal direction from an upper left corner; and place the existing image in the empty unit cell.

According to one or more embodiments of the present disclosure, the image synthesizer is further configured to, based on a command to enlarge a specific image from among a plurality of displayed images on the screen being input through the user interface: enlarge the specific image such as to cover at least one image from among the plurality of displayed images; find at least one empty unit cell in an order of priority by scanning the screen in a horizontal direction; and place, based on the order of priority, the at least one image that is covered in the at least one empty unit cell.

According to one or more embodiments of the present disclosure, the image synthesizer is further configured to, based on finding no empty unit cells as a result of the scanning, place the at least one image that is covered in at least one from among empty unit cells obtained by expanding the plurality of unit cells.

According to one or more embodiments of the present disclosure, the image synthesizer is further configured to, based on a command to change a size or position of at least one from among displayed images on the screen being input through the user interface, change and display the at least one from among the displayed images according to the command and, based on a return command being input through the user interface, display an entirety of each of the displayed images by auto-fitting the displayed images within the screen.

According to embodiments of the present disclosure, an image monitoring method may be provided and performed by a computing device including a processor and a memory that stores instructions executable by the processor. The image monitoring method may include: receiving a plurality of images from a plurality of cameras through at least one channel; selecting at least two images to be displayed on a screen from among the plurality of images based on receiving at least one user input through a user interface; decoding the at least two images that are selected; and displaying the at least two images, that are decoded, on the screen, wherein the screen includes a plurality of unit cells, and wherein the displaying includes increasing an amount of the plurality of unit cells by expanding the plurality of unit cells first in a horizontal row direction and then in a vertical column direction, based on a condition that a number of the plurality of unit cells in the horizontal row direction is greater than or equal to a number of the plurality of unit cells in the vertical column direction is always satisfied.

According to one or more embodiments of the present disclosure, the displaying further includes placing a first image and a second image, among the at least two images, on the screen such that a relative position of the first image does not change when the second image is placed.

According to one or more embodiments of the present disclosure, the plurality of unit cells have a same reference aspect ratio, and the image monitoring method further includes: placing a first image from among the at least two images in one unit cell from among the plurality of unit cells based on an aspect ratio of the first image being smaller than or equal to the reference aspect ratio; or placing the first image across two or more unit cells from among the plurality of unit cells based on the aspect ratio of the first image being greater than the reference aspect ratio.

According to one or more embodiments of the present disclosure, the image monitoring method further includes: placing the first image across the two or more unit cells based on the aspect ratio of the first image being greater than the reference aspect ratio; and placing a second image after the first image is placed, wherein the placing the second image includes: placing, based on an aspect ratio of the second image being smaller than or equal to an aspect ratio of an empty area of the screen that is adjacent to the first image placed in the two or more unit cells, the second image in the empty area of the screen; or placing based on the aspect ratio of the second image being greater than the aspect ratio of the empty area, the second image in another unit cell that is spaced apart from the first image.

According to one or more embodiments of the present disclosure, the image monitoring method further includes: determining in advance a number of the plurality of unit cells required for placing the at least two images that are selected; and placing the at least two images in the number of the plurality of unit cells determined such that a number of empty unit cells among the plurality of unit cells is minimized.

According to one or more embodiments of the present disclosure, the image monitoring method further includes: receiving a command, input through the user interface, to place a second image from among the at least two images at a first position where a first image from among the at least two images is already placed; and placing the second image in a unit cell from among the plurality of unit cells that is at a second position next to the first position.

According to one or more embodiments of the present disclosure, the image monitoring method further includes: receiving a command, input through the user interface, to move a specific image from among a plurality of displayed images on the screen; and based on receiving the command: placing the specific image at a position at which an existing image is present; finding an empty unit cell from among the plurality of unit cells by scanning the screen in a horizontal direction from an upper left corner; and placing the existing image in the empty unit cell.

According to one or more embodiments of the present disclosure, the image monitoring method further includes: receiving a command, input through the user interface, to enlarge a specific image from among a plurality of displayed images on the screen; and based on receiving the command: enlarging the specific image such as to cover at least one image from among the plurality of displayed images; finding at least one empty unit cell in an order of priority by scanning the screen in a horizontal direction; and placing, based on the order of priority, the at least one image that is covered in the at least one empty unit cell.

According to one or more embodiments of the present disclosure, the image monitoring method further includes: receiving a command, input through the user interface, to enlarge a specific image from among a plurality of displayed images on the screen; and based on receiving the command: enlarging the specific image such as to cover at least one image from among the plurality of displayed images; finding no empty unit cells by scanning the screen in a horizontal direction; and placing, based on the finding no empty unit cells, the at least one image that is covered in empty unit cells obtained by expanding the plurality of unit cells.

According to one or more embodiments of the present disclosure, the image monitoring method further includes: receiving a command, input through the user interface, to change a size or position of at least one from among displayed images on the screen; changing and displaying the at least one from among displayed image according to the command; and, displaying, based on a return command being input through the user interface, an entirety of each of the displayed images by auto-fitting the displayed images within the screen.

According to embodiments of the present disclosure, it is possible to optimally place images even when a plurality of images are sequentially added or simultaneously added, or moved or edited on a screen of an image monitoring device.

However, aspects of embodiments of the present disclosure are not restricted to the ones set forth herein. The above and other aspects of embodiments of the present disclosure will become more apparent to one of ordinary skill in the art to which the present disclosure pertains by referencing the detailed description of the present disclosure given below.

### BRIEF DESCRIPTION OF DRAWINGS

FIG. 1 illustrates a configuration of a video surveillance system according to an embodiment of the present disclosure;

FIG. 2 is a block diagram of an image monitoring device according to an embodiment of the present disclosure;

FIGS. 3A through 3C illustrate cases of unit cell expansion (additional division) according to an embodiment of the present disclosure;

FIGS. 4A and 4B illustrate individual allocation scenarios according to embodiments of the present disclosure;

FIGS. 5A and 5B illustrate batch allocation scenarios according to embodiments of the present disclosure;

FIGS. 6A through 6C illustrate processing processes when an image already exists at an allocated position according to embodiments of the present disclosure;

FIGS. 7A through 7C illustrate scenarios of moving one of images already placed on a screen according to embodiments of the present disclosure;

FIGS. 8A through 8C illustrate scenarios of enlarging one of images already placed on a screen according to embodiments of the present disclosure;

FIGS. 9A through 9E illustrate a scenario in which a screen is changed to an auto-fit state by a return command selected after the screen is changed by a user according to embodiments of the present disclosure;

FIGS. 10A and 10B illustrate a scenario in which a screen is changed to an auto-fit state by a return command selected after the screen is changed by a user according to embodiments of the present disclosure;

FIG. 11 illustrates an implementation example of a computing device that realizes the image monitoring device of FIG. 2 according to embodiments of the present disclosure; and

FIG. 12 is a flowchart illustrating an image monitoring method performed by a computing device such as the one in FIG. 10 according to an embodiment of the present disclosure.

### DETAILED DESCRIPTION

Advantages and features of embodiments (including methods) of the present disclosure will become apparent from the descriptions of non-limiting example embodiments below with reference to the accompanying drawings. However, embodiments of the present discourse are not limited to the example embodiments described herein and may be implemented in various ways. The example embodiments are provided for making the present disclosure thorough and for fully conveying the scope of the present disclosure to those skilled in the art. Like reference numerals denote like elements throughout the descriptions.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for describing example embodiments rather than limiting the present disclosure. As used herein, the singular forms are intended to include plural forms as well, unless the context clearly indicates otherwise. Throughout this specification, the word “comprise” (or “include”) and variations such as “comprises” (or “includes”) or “comprising” (or “including”) will be understood to imply the inclusion of stated elements but not the exclusion of any other elements.

Hereinafter, non-limiting example embodiments of the present disclosure will be described in detail with reference to the accompanying drawings.

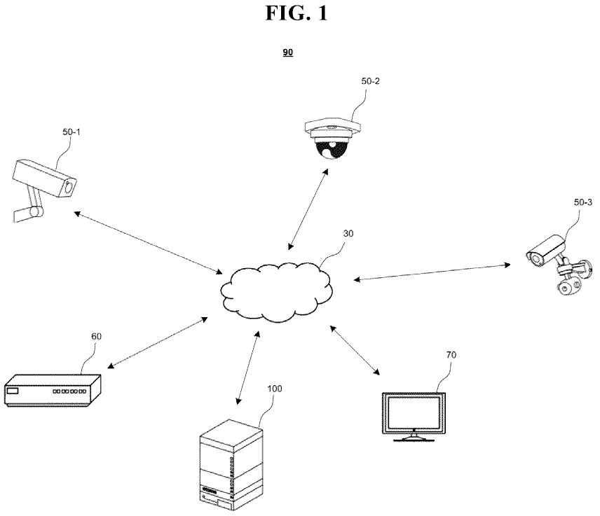

FIG. 1 illustrates a configuration of a video surveillance system 90 according to an embodiment of the present disclosure. With reference to FIG. 1, the video surveillance system 90 may include a plurality of camera devices (e.g., camera devices 50-1, 50-2, and 50-3) connected to each other through a network 30, a network video recorder (NVR) 60, an image monitoring device 100 (e.g., a video management system), and a user terminal device 70.

The camera devices 50-1, 50-2 and 50-3 may have the function of capturing images and generating metadata. Here, the term “image” is used to encompass a still picture and a moving picture. The moving picture may also be generally called a video.

The images and metadata captured by the camera devices 50-1, 50-2 and 50-3 may be stored in the NVR 150 and provided at the request of the image monitoring device 100.

The image monitoring device 100 may search for an image in which an event has occurred among the stored images using the metadata in response to a user's search request and may take action (e.g., alarm raising, object tracking, etc.) corresponding to the event.

The user terminal device 70 may be implemented as a personal computer, a mobile terminal, etc., and may connect to the camera devices (e.g., the camera devices 50-1, 50-2, and 50-3), the NVR 60, the image monitoring device 100, etc., through the network 30.

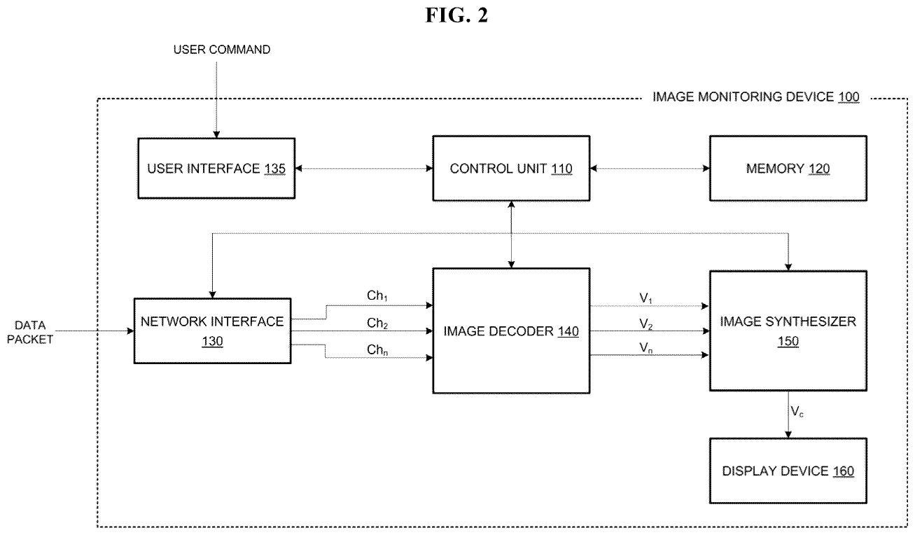

FIG. 2 is a block diagram of an image monitoring device 100 according to an embodiment of the present disclosure.

A controller 110 may act as a controller that controls the operation of other components of the image monitoring device 100. In addition, a memory 120 may be provided that is a storage medium that stores execution results of the controller 110 and/or stores data for the operation of the controller 110 and may be implemented as a volatile memory or a nonvolatile memory. The controller 110 may be implemented by at least one processor such as a central processing unit (CPU), graphic processing unit (GPU) and/or another type of microprocessor, and an internal memory to perform the functions described herein by loading corresponding computer code or instructions stored in an internal or external storage such as one or more memory devices to the internal memory and execute the computer code or instructions.

A network interface 130 may be provided that communicates with the plurality of camera devices 50-1, 50-2 and 50-3 as described above and receives images of the camera devices 50-1, 50-2 and 50-3 in the form of data packets through channels to which the camera devices 50-1, 50-2 and 50-3 are connected, respectively.

The network interface 130 may be implemented as a wired module such as Ethernet or a wireless module such as wireless local area network (WLAN) and may have an image transmission protocol, such as real time streaming protocol/real-time transport protocol (RTSP/RTP) or websocket, on the module. For this purpose, the network interface 130 may include any one or any combination of a digital modem, a radio frequency (RF) modem, an antenna circuit, a WiFi chip, and related software and/or firmware.

An image decoder 140 may be provided and receive, from the network interface 130, encoded image data Ch₁, Ch₂, and Chₙ received from the camera devices 50-1, 50-2 and 50-3 through the channels, respectively, and decode the encoded image data Ch₁, Ch₂, and Chₙ according to a predetermined compression standard (e.g., MPGE-4, H.264, HEVC, etc.) into visually identifiable images. Images V₁, V₂, and Vₙ obtained from decoding the encoded image data Ch₁, Ch₂, and Chₙ may be provided to an image synthesizer 150 of the image monitoring device 100. The image decoder 140 may be implemented by computer code or instructions which may be stored in the internal or external storage and loaded to the internal memory of the controller 110 to be executed to perform the functions described herein. Alternatively or additionally, the image decoder 140 may be implemented by dedicated hardware including one or more of microprocessors, logic gates or circuits, registers, memories, interface circuits, etc., configured to perform the functions described herein in association with the controller 110.

A user may select an image to be displayed on a screen from among the images V₁, V₂, and Vₙ through a user interface 135 of the image monitoring device 100. That is, even if there are multiple images per channel, the user can input a user command to display only images containing events or images of a desired channel on the screen. The user interface 135 may be implemented as various devices such as a keyboard, a touch screen, a mouse, a digitizer, and an electronic pen.

The image synthesizer 150 may synthesize all or some of the decoded images (e.g., the images V₁, V₂, and Vₙ) into one screen image based on the user command received through the user interface 135, and display the screen image on the screen. At this time, the display device 160 may render the screen image received from the image synthesizer 150 into a format suitable for the display device 160 and may then display the rendered image on the screen.

For example, when a new second image is additionally selected after a first image is selected and displayed on the screen, the image synthesizer 150 may synthesize the first and second images and display them together on the screen composed of a plurality of unit cells. The image synthesizer 150 may be implemented by computer code or instructions which may be stored in the internal or external storage and loaded to the internal memory of the controller 110 to be executed to perform the functions described herein. Alternatively or additionally, the image synthesizer 150 may be implemented by dedicated hardware including one or more of microprocessors, logic gates or circuits, registers, memories, interface circuits, etc., configured to perform the functions described herein in association with the controller 110.

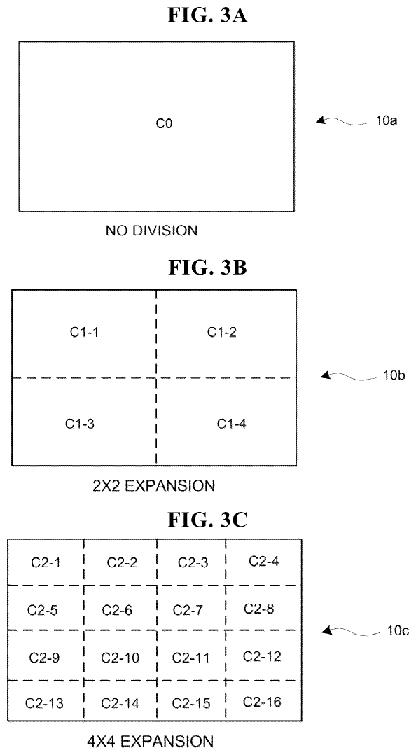

In the present disclosure, “unit cells” refer to a plurality of virtual quadrangular unit areas into which one screen (e.g., a screen 10a, 10b, or 10c of FIGS. 3A-C) is divided. As illustrated in FIG. 3A, when there is no division, the screen 10a may be allocated only a single unit cell C0. However, as illustrated in FIGS. 3B-C, when the screen (e.g., the screen 10b or 10c) is divided into a plurality of unit cells such as a 2×2 expansion (e.g., unit cells C1-1 through C1-4) or 4×4 expansion (e.g., unit cells C2-1 through C2-16), images may be placed based on the unit cells.

However, since an aspect ratio of an image may vary according to camera device, aspect ratios of the unit cells and the images may not completely match. However, the unit cells may be set to have an aspect ratio of 16/9 (about 1.778), that is, a reference aspect ratio of full high-definition (HD) or ultra HD resolution which is most commonly used in various camera devices. If a plurality of images having the reference aspect ratio are displayed on the screen (e.g., the screen 10a, 10b, or 10c) regardless of the current number of unit cells into which the screen is divided, boundaries or grid lines of the images will match boundaries of the unit cells. However, if a special image having a different aspect ratio from the reference aspect ratio is included in the images, one image (e.g., a panorama, a hallway view) may be displayed across two or more unit cells, or a plurality of images may be displayed in one unit cell.

Therefore, in embodiments of the present disclosure, the unit cells may have the same reference aspect ratio as each other. In addition, if an aspect ratio of an additionally selected image is smaller than or equal to the reference aspect ratio, the selected image may be placed in one unit cell. If the aspect ratio of the selected image is greater than the reference aspect ratio, the selected image may be placed across two or more unit cells.

In addition, in embodiments of the present disclosure, a plurality of images may be optimally placed on a plurality of unit cells (e.g., to have as little empty space as possible). However, even if an image is added to an existing image, the position of the existing image is not changed. This is because if an image placed in a unit cell 1 is suddenly moved to a different position by considering only the optimal placement, it may cause confusion to a user.

In addition, in embodiments of the present disclosure, considering that a general image is longer horizontally than vertically, when a unit cell needs to be expanded, it may be first expanded in a horizontal direction (e.g., a horizontal row direction) and then in a vertical direction (e.g., a vertical column direction). For example, the unit cell may be first expanded to (e.g., divided into) 2×1 unit cells when a next image is added while only one image is being displayed on the screen and then expanded to (e.g., divided into) 2×2 unit cells when another next image is further added. According to this principle, the number of the unit cells in the horizontal direction is always greater than or equal to the number of the unit cells in the vertical direction. For example, 5×4 expansion can exist on the screen, but 4×5 expansion cannot exist.

Basic placement principles commonly applied to various scenarios of embodiments of the present disclosure can be summarized as follows.

(1) As the number of images allocated (added) increases, a unit cell is also expanded (e.g., divided into a plurality of unit cells).

(2) The expansion of the unit cell does not include a case where the number of vertical columns exceeds the number of horizontal columns (e.g., the unit cell may be expanded in the order of 1, 2×2, 3×2, 3×3, 4×3, and 4×4).

(3) The order in which images are allocated to unit cells created as a result of the expansion of the unit cell is from the upper left to the lower right.

(4) If an empty area is created due to a mismatch in aspect ratio, it is left empty until an image with an aspect ratio that can fill the area is added.

(5) If there is an empty unit cell between the unit cells already allocated the images, the empty unit cell is filled with an image according to the allocation order of (1) to (4).

(6) It is also allowed to allocate the same channel or the same image repeatedly.

Various scenarios in which the image synthesizer 150 expands (divides) a unit cell according to the number of images and additionally places images on the resulting unit cells will be exemplified with reference to the drawings.

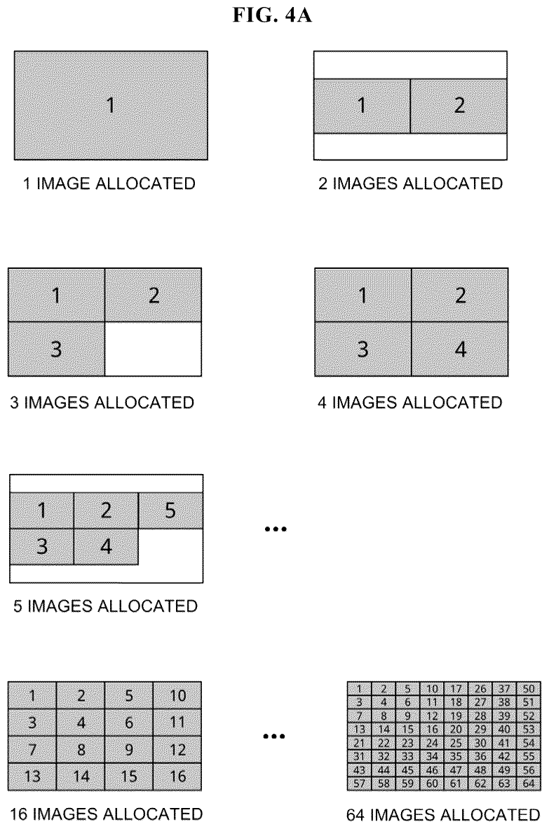

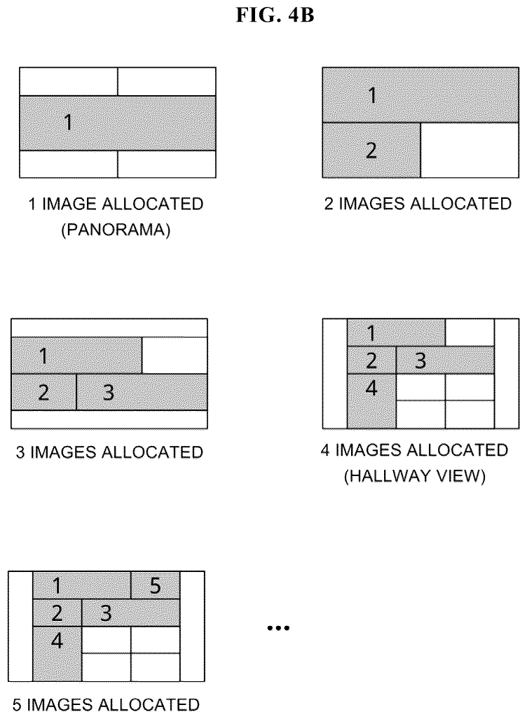

FIGS. 4A and 4B illustrate individual allocation scenarios according to embodiments of the present disclosure. In particular, FIG. 4A illustrates a case where aspect ratios of a unit cell and an image match (i.e., both have the reference aspect ratio), and FIG. 4B illustrates a case where there is an image having an aspect ratio different from the reference aspect ratio. In addition, the individual allocation refers to a situation where an additional image is placed when an image is already placed. As an example, FIG. 4A illustrates a case where 64 images (i.e., images 1 to 64) are allocated, and FIG. 4B illustrates a case where five images (i.e., images 1 to 5) are allocated.

When aspect ratios of unit cells and images match as in FIG. 4A, boundaries (or grid lines) between the images and boundaries of the unit cells match. Therefore, if there is no empty unit cell or empty area that can be allocated an image on a screen, the image synthesizer 150 may secure an empty unit cell by expanding the number of unit cells and then places an additional image.

In addition, if a horizontally long panorama (e.g., image 1 or image 3) or a vertically long hallway view (e.g., an image 4) is included, an image may be allocated as shown in FIG. 4B.

For example, when another image is added in a state where a special image such as the panorama or hallway view is placed in two or more unit cells, the following rules may be followed. That is, if an aspect ratio of the added image is less than or equal to an aspect ratio of an empty area remaining after the special image is placed in two or more unit cells, the image synthesizer 150 may place the third image in the empty area. In addition, if the aspect ratio of the added image is greater than the aspect ratio of the remaining empty area, the image synthesizer 150 may place the added image in another unit cell.

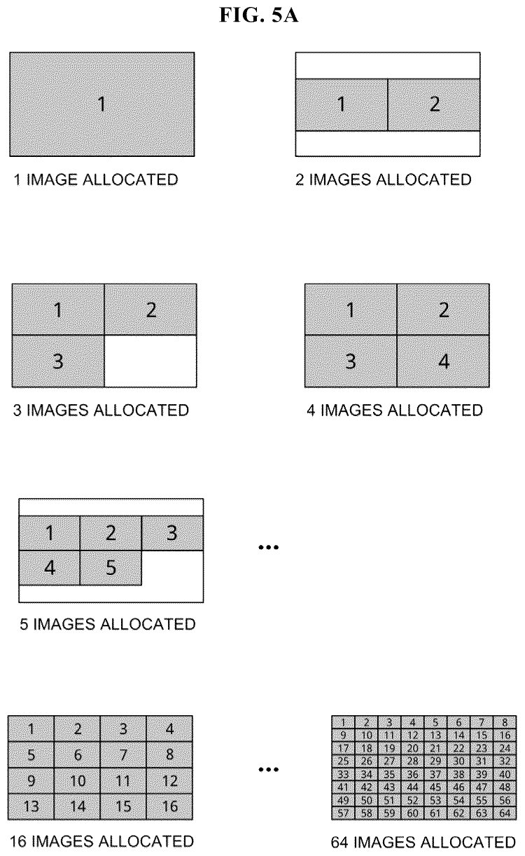

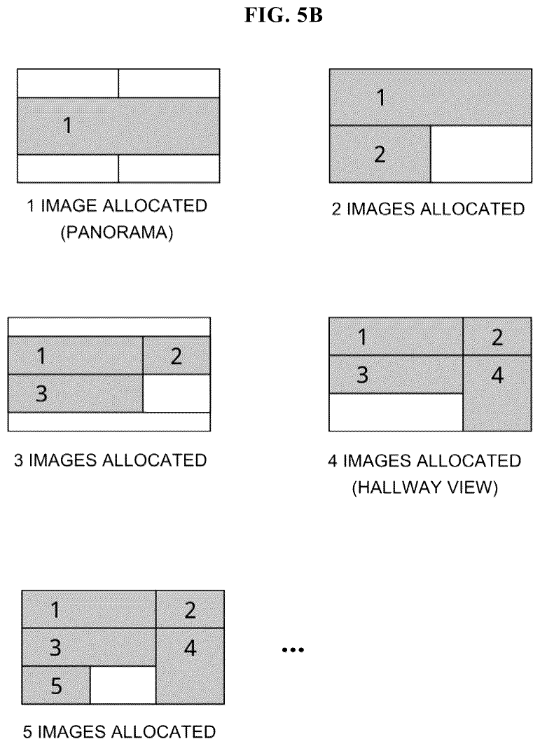

FIGS. 5A and 5B illustrate batch allocation scenarios according to embodiments of the present disclosure. In particular, FIG. 5A illustrates a case where aspect ratios of a unit cell and an image match, and FIG. 5B illustrates a case where there is an image having an aspect ratio different from the reference aspect ratio. The batch allocation refers to a situation where a plurality of images are to be placed simultaneously. As an example, FIG. 5A illustrates a case where 64 images (i.e., images 1 to 64) are allocated, and FIG. 5B illustrates a case where five images (i.e., images 1 to 5) are allocated.

For example, when a user inputs a command to add a plurality of images, the image synthesizer 150 may determine, in advance, the number of unit cells required for the images. In this calculation, a general image is counted as 1, and a special image such as a panorama or a hallway view is counted as 2 or more. Through this, the image synthesizer 150 may place the images in the determined number of unit cells. Here, the images may be placed on the determined number of unit cells regardless of the order of the images in such a way that minimizes empty areas within the unit cells.

A specific batch allocation scenario may be performed according to the following rules.

(1) In the case of batch allocation, the number of unit cells to be occupied by a plurality of images is determined in advance (e.g., 3×3 division is determined if nine unit cells are required, and 5×4 division is determined if seventeen unit cells are required).

(2) At this time, calculation is performed including a case where there is a special image that occupies two or more unit cells (e.g., total number of unit cells =number of general images+number of special images times two).

(3) Images are allocated in order from left to right and from top to bottom of a screen.

(4) Unit cells are filled as much as possible while being skipped if a next image cannot be allocated due to an image that occupies two or more unit cells (empty areas may be created).

(5) If a next image cannot be allocated with the current unit cell division, the unit cells are expanded to the right or bottom (additional division).

(6) A camera device that occupies one space is not allocated to unit cells created as a result of the expansion of the unit cells (i.e., the created unit cells are used only for expansion purposes).

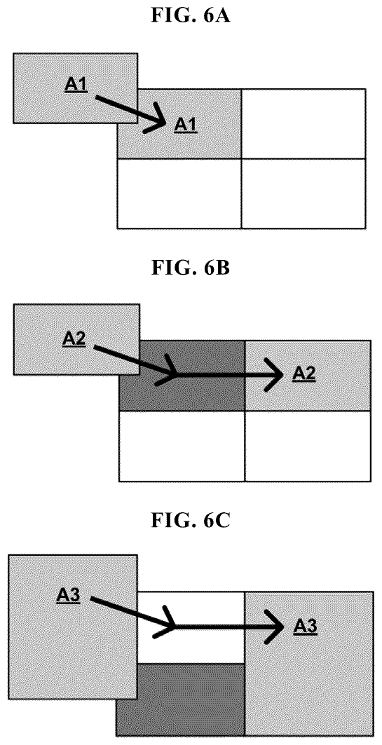

FIGS. 6A-C illustrate processing operations when an image does not exist at an allocated position or already exists at an allocated position. This is a scenario that includes when a command (e.g., a drag and drop operation) to place an additional image on top of an existing image is input through the user interface 135. At this time, the image synthesizer 150 may place the additional image in a unit cell located next to the allocated position.

Specifically, FIG. 6A illustrates a first case where a command to place an additional image A1 in an empty unit cell is input. In this case, the additional image A1 may be simply placed in the empty unit cell.

FIG. 6B illustrates a second case where a command to place an additional image A2 on top of an existing image (e.g., an image in a top-left unit cell) is input. Since moving the existing image may cause confusion to a user, the additional image A2 is automatically moved to a next cell (e.g., a unit cell to the right of the top-left unit cell) and placed there.

In addition, FIG. 6C illustrates a third case where an empty area (e.g., an empty top-left unit cell) exists at a position where a special image A3, such as a hallway view or a panorama, is to be placed, but has an insufficient aspect ratio. In this case, the special image A3 may be automatically moved to a next cell (e.g., a unit cell to the right of the top-left unit cell) and placed therein.

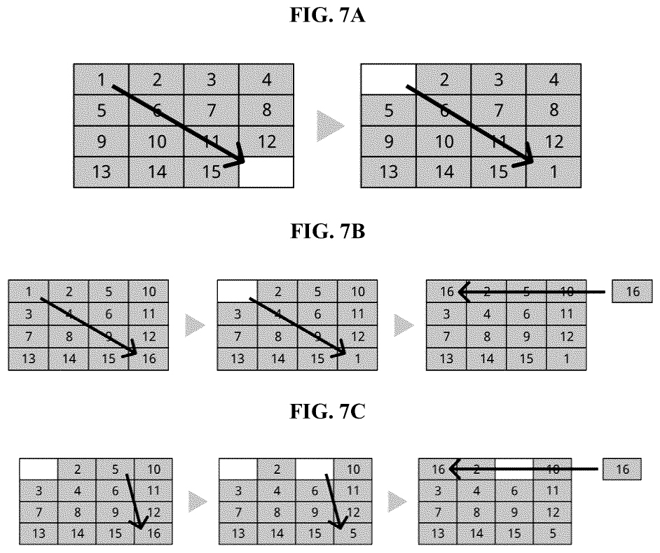

FIGS. 7A through 7C illustrate scenarios of moving one of images already placed on a screen. In particular, FIG. 7A illustrates a case where there is no image at a desired position, and FIGS. 7B and 7C illustrate cases where there is an image at a desired position.

That is, when a command to move a specific image among the images is input through the user interface 135, the image synthesizer 150 may place the specific image in an empty unit cell if there is the empty unit cell at a position to which the specific image is to be moved. For example, referring to FIG. 7A, based on receiving a command to move the image 1 to the bottom-right corner unit cell being input through the user interface 135, the image synthesizer 150 may place the image in the bottom-right corner unit cell based on such unit cell being empty.

However, if there is an image at the position to which the specific image is to be moved, the image synthesizer 150 may place the image existing at the position in an empty unit cell found first by scanning the screen in the horizontal direction from an upper left corner.

Referring to FIG. 7B, when moving an image 1 to the position (e.g., the bottom-right corner unit cell) of another image 16 in a state where sixteen images are already placed, the image synthesizer 150 may first place the image 1 at the position of the image 16. After that, the image synthesizer 150 may place the image 16 at the previous position of the image 1 with an empty unit cell (e.g., the top-left corner unit cell).

Referring to FIG. 7C, when moving an image 5 to the position of another image 16 in a state where fifteen images are already placed, the image synthesizer 150 may first place the image 5 at the position of the image 16. At this time, there may be two empty unit cells left where the image 16 can be placed. In such case, the image synthesizer 150 may not simply swap the image 16 with the image 5, but instead may follow the basic placement principles described above. That is, the image 16 may be placed in a first empty unit cell (e.g., the top-left corner unit cell), not in a unit cell located at the previous position of the image 5.

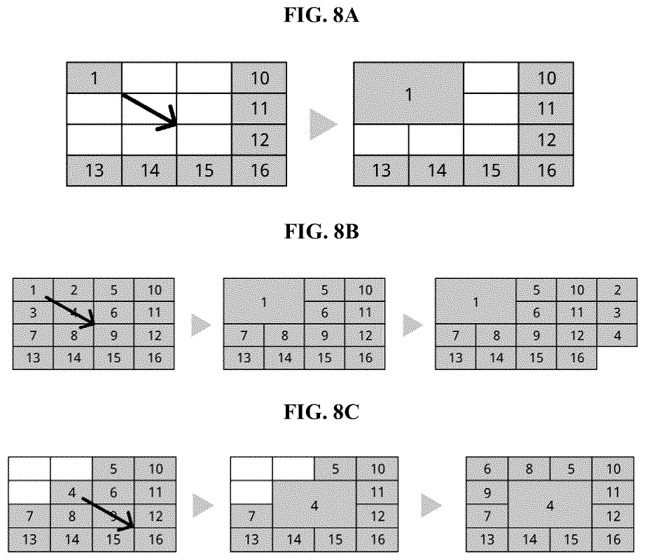

FIGS. 8A through 8C illustrate scenarios of enlarging one of images already placed on a screen. In particular, FIG. 8A illustrates a case where an image does not exist in an area (e.g., a group of empty unit cells adjacent to the image 1) where a specific image (e.g., the image 1) is to be enlarged, and FIGS. 8B and 8C respectively illustrate cases where an image(s) exists in an area (e.g., a group of filled unit cells adjacent to the image 1 or image 4) where a specific image (e.g., the image 1 or the image 4) is to be enlarged.

Specifically, when a command to enlarge a specific image among the images is input through the user interface 135, the image synthesizer 150 may allocate images according to the following principles.

1) A selected image is enlarged first, and then existing images that become covered by the selected image, are moved to other positions.

2) A scenario of re-allocating the existing images follows the basic arrangement principles described above.

For example, with reference to FIGS. 8A-8C, the image synthesizer 150 may enlarge and place the specific image (e.g., image 1 in FIGS. 8A-B, and image 4 in FIG. 8C) and place images (e.g., images 2-4 in FIG. 8B and images 6, 8, and 9 in FIG. C) covered by the enlargement of the specific image (e.g., image 1) in order of priority in empty unit cells found first by scanning the screen in the horizontal direction (see FIGS. 8B and 8C).

Here, if no empty unit cells are found as a result of the scanning as in FIG. 8C, the image synthesizer 150 may place the covered images (e.g., images 6, 8, and 9) in empty unit cells secured by expanding (e.g., additionally dividing) the unit cells.

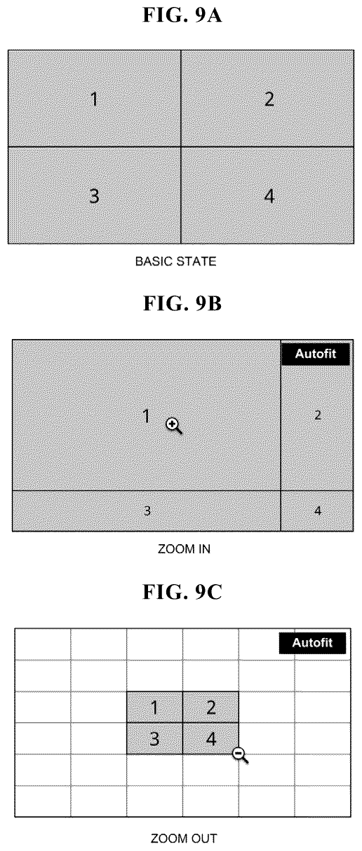

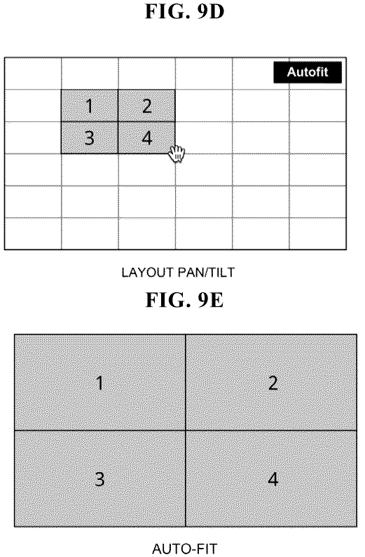

FIGS. 9A-E and 10A-B illustrate scenarios in which a screen is changed to an auto-fit state based on a return command being selected after the screen is changed by a user.

In particular, FIGS. 9A-E illustrate a screen in its original basic state, the screen in a zoomed-in state, the screen in a zoomed-out state, the screen in a layout pan/tilt state, and the screen in an auto-fit execution state, respectively.

Specifically, when a command (zoom in, zoom out, pan/tilt, etc.) to change the size or position of at least one of the images is input through the user interface 135, the image synthesizer 150 may first change and display the at least one image according to the command. In addition, when a return command is input through the user interface 135, the image synthesizer 150 may display the entirety of the images by auto-fitting them within the screen (see FIG. 9E). The return command may be executed automatically after a predetermined amount of time has elapsed or may be executed when a user presses a specific button (e.g., the Autofit button shown in FIGS. 9B-D).

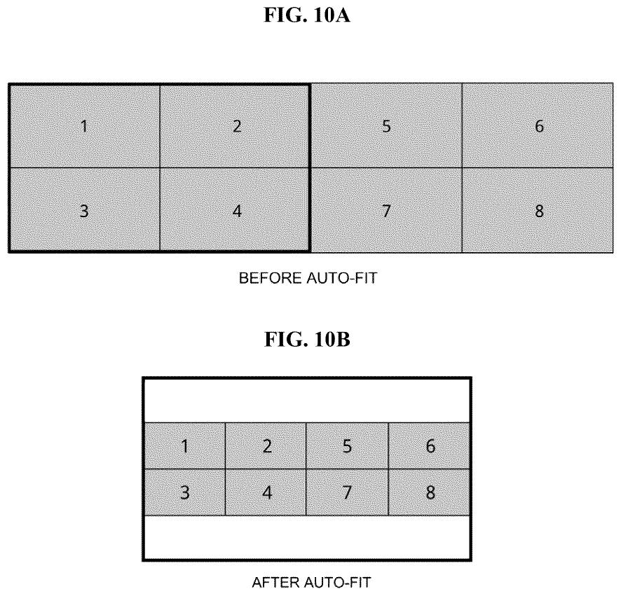

As illustrated in FIGS. 10A-B, when the number of images being monitored by a user is eight, only four images (e.g., images 1 through 4) may be displayed first to the user on the screen (see FIG. 10A), and the remaining four images (e.g., images 5 through 8) may not be displayed. Even in this case, if the return command is input, the entire eight images may be displayed by being auto-fit within the screen (see FIG. 10B).

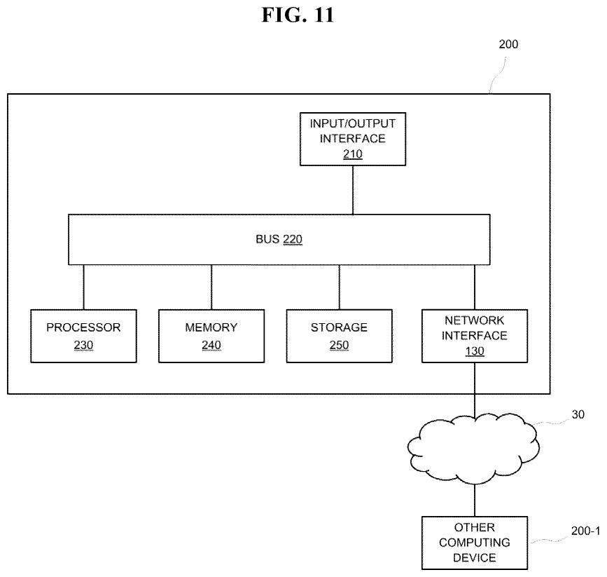

FIG. 11 illustrates an implementation example of a computing device 200 that realizes the image monitoring device 100 of FIG. 2.

The computing device 200 may include a bus 220, a processor 230, a memory 240, a storage 250, an input/output interface 210, and a network interface 130. The bus 220 may be a data transmission path used by the processor 230, the memory 240, the storage 250, the input/output interface 210, and the network interface 130 to transmit and receive data to and from each other. However, a method of connecting the processor 230, etc., to each other is not limited to a bus connection. The processor 230 may be a computational processing unit such as a central processing unit (CPU), a graphics processing unit (GPU), or a digital signal processor (DSP). The memory 240 may be a memory such as a random access memory (RAM) or a read only memory (ROM). The storage 250 may be a storage device such as a hard disk, a solid state drive (SSD), or a memory card. The storage 250 may also be a memory such as a RAM or a ROM.

The input/output interface 210 may be an interface for connecting the computing device 200 to an input/output device. For example, a keyboard, a mouse, etc., may be connected to the input/output interface 210.

The network interface 130 may be an interface for connecting the computing device 200 to an external device so that the computing device 200 can communicate with the external device to transmit and receive transmission packets. The network interface 130 may be a network interface for connecting to a wired line or may be a network interface for connecting to a wireless line. For example, the computing device 200 may be connected to another computing device 200-1 through a network 30.

The storage 250 may store program modules that implement each function of the computing device 200. The processor 230 may execute each of the program modules to implement each function corresponding to the program module. Here, when the processor 230 executes each module, it may read the modules onto the memory 240 and then execute them.

However, the hardware configuration of the computing device 200 is not limited to the configuration illustrated in FIG. 11. For example, each program module may be stored in the memory 240. In this case, the computing device 200 may not include the storage 250.

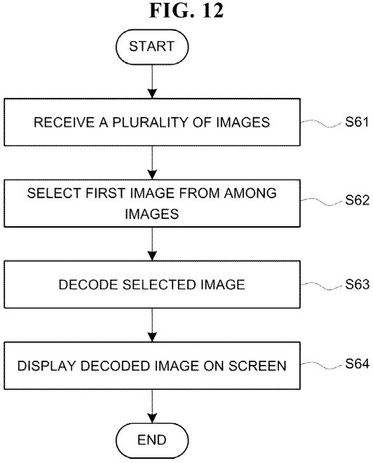

FIG. 12 is a flowchart illustrating an image monitoring method according to an embodiment of the present disclosure, performed by a computing device 200, such as the one in FIG. 10, which includes a processor and a memory that stores instructions executable by the processor.

First, a network interface 130 may receive a plurality of images from a plurality of cameras through each channel (operation S61).

Next, a user may select a first image to be displayed on a screen (e.g., the screen 10a, 10b, or 10c in FIGS. 3A-C) from among the received images through a user interface 135 (operation S62), and an image decoder 140 may decode the selected image (operation S63).

Accordingly, an image synthesizer (operation S64) may display the decoded image on the screen 10 (operation S64).

In operation S64, if a second image is additionally selected via the user interface 135, the first image and the second image may be displayed together on the screen composed of a plurality of unit cells.

In addition, in response to the addition of the second image, the unit cells may be expanded (e.g., divided) in a horizontal row direction first and then expanded (e.g., divided) in a vertical column direction. Here, the condition that the horizontal number of the unit cells is greater than or equal to the vertical number of the unit cells may be always satisfied.

The first image and the second image may be placed on the screen such that the relative position of the first image does not change even if the second image is added.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific example embodiments described herein, and that modifications and other embodiments are within the spirit and scope of the present disclosure.

What is claimed is:

1. An image monitoring device comprising:
a network interface configured to receive a plurality of images from a plurality of cameras through at least one channel;
a user interface configured to allow a user to select at least a first image to be displayed on a screen from among the plurality of images that are received;
an image decoder configured to decode the first image that is selected; and
an image synthesizer configured to display the first image, that is decoded, on the screen,
wherein the screen comprises a plurality of unit cells,
wherein the image synthesizer is further configured to, based on a second image being additionally selected via the user interface:
display the first image and the second image together on the screen; and
increase an amount of the plurality of unit cells by expanding the plurality of unit cells first in a horizontal row direction and then in a vertical column direction, based on a condition that a number of the plurality of unit cells in the horizontal row direction is greater than or equal to a number of the plurality of unit cells in the vertical column direction is always satisfied.

2. The image monitoring device of claim 1, wherein the image synthesizer is further configured to place the first image and the second image on the screen such that a relative position of the first image does not change when the second image is placed.

3. The image monitoring device of claim 1, wherein the plurality of unit cells have a same reference aspect ratio, and the image synthesizer is further configured to:
place the first image in one unit cell from among the plurality of unit cells based on an aspect ratio of the first image being smaller than or equal to the reference aspect ratio; and
place the first image across two or more unit cells from among the plurality of unit cells based on the aspect ratio of the first image being greater than the reference aspect ratio.

4. The image monitoring device of claim 3, wherein the image synthesizer is further configured to, based on a third image being added after the first image is placed in the two or more unit cells:
place, based on an aspect ratio of the third image being smaller than or equal to an aspect ratio of an empty area of the screen that is adjacent to the first image placed in the two or more unit cells, the third image in the empty area of the screen; and
place, based on the aspect ratio of the third image being greater than the aspect ratio of the empty area, the third image in another unit cell that is spaced apart from the first image.

5. The image monitoring device of claim 1, wherein the image synthesizer is further configured to determine in advance a number of the plurality of unit cells required for placing a plurality of selected images, and place the plurality of selected images in the number of the plurality of unit cells determined such that a number of empty unit cells among the plurality of unit cells is minimized.

6. The image monitoring device of claim 5, wherein the image synthesizer is further configured to, based on a command to place the second image at a first position where the first image is already placed being input through the user interface, place the second image in a unit cell from among the plurality of unit cells that is at a second position next to the first position.

7. The image monitoring device of claim 5, wherein the image synthesizer is further configured to, based on a command to move a specific image from among a plurality of displayed images on the screen being input through the user interface:
place the specific image at a position at which an existing image is present;
find an empty unit cell from among the plurality of unit cells by scanning the screen in a horizontal direction from an upper left corner; and
place the existing image in the empty unit cell.

8. The image monitoring device of claim 5, wherein the image synthesizer is further configured to, based on a command to enlarge a specific image from among a plurality of displayed images on the screen being input through the user interface:
enlarge the specific image such as to cover at least one image from among the plurality of displayed images;
find at least one empty unit cell in an order of priority by scanning the screen in a horizontal direction; and
place, based on the order of priority, the at least one image that is covered in the at least one empty unit cell.

9. The image monitoring device of claim 8, wherein the image synthesizer is further configured to, based on finding no empty unit cells as a result of the scanning, place the at least one image that is covered in at least one from among empty unit cells obtained by expanding the plurality of unit cells.

10. The image monitoring device of claim 1, wherein the image synthesizer is further configured to, based on a command to change a size or position of at least one from among displayed images on the screen being input through the user interface, change and display the at least one from among the displayed images according to the command and, based on a return command being input through the user interface, display an entirety of each of the displayed images by auto-fitting the displayed images within the screen.

11. An image monitoring method performed by a computing device including a processor and a memory that stores instructions executable by the processor, the image monitoring method comprising:
receiving a plurality of images from a plurality of cameras through at least one channel;
selecting at least two images to be displayed on a screen from among the plurality of images based on receiving at least one user input through a user interface;
decoding the at least two images that are selected; and
displaying the at least two images, that are decoded, on the screen,
wherein the screen includes a plurality of unit cells, and
wherein the displaying comprises increasing an amount of the plurality of unit cells by expanding the plurality of unit cells first in a horizontal row direction and then in a vertical column direction, based on a condition that a number of the plurality of unit cells in the horizontal row direction is greater than or equal to a number of the plurality of unit cells in the vertical column direction is always satisfied.

12. The image monitoring method of claim 11, wherein the displaying further comprises placing a first image and a second image, among the at least two images, on the screen such that a relative position of the first image does not change when the second image is placed.

13. The image monitoring method of claim 11, wherein the plurality of unit cells have a same reference aspect ratio, and the image monitoring method further comprises:
placing a first image from among the at least two images in one unit cell from among the plurality of unit cells based on an aspect ratio of the first image being smaller than or equal to the reference aspect ratio; or
placing the first image across two or more unit cells from among the plurality of unit cells based on the aspect ratio of the first image being greater than the reference aspect ratio.

14. The image monitoring method of claim 13, further comprising:
placing the first image across the two or more unit cells based on the aspect ratio of the first image being greater than the reference aspect ratio; and
placing a second image after the first image is placed, wherein the placing the second image comprises:
placing, based on an aspect ratio of the second image being smaller than or equal to an aspect ratio of an empty area of the screen that is adjacent to the first image placed in the two or more unit cells, the second image in the empty area of the screen; or
placing based on the aspect ratio of the second image being greater than the aspect ratio of the empty area, the second image in another unit cell that is spaced apart from the first image.

15. The image monitoring method of claim 11, further comprising:
determining in advance a number of the plurality of unit cells required for placing the at least two images that are selected; and
placing the at least two images in the number of the plurality of unit cells determined such that a number of empty unit cells among the plurality of unit cells is minimized.

16. The image monitoring method of claim 15, further comprising:
receiving a command, input through the user interface, to place a second image from among the at least two images at a first position where a first image from among the at least two images is already placed; and
placing the second image in a unit cell from among the plurality of unit cells that is at a second position next to the first position.

17. The image monitoring method of claim 15, further comprising:
receiving a command, input through the user interface, to move a specific image from among a plurality of displayed images on the screen; and
based on receiving the command:
placing the specific image at a position at which an existing image is present;
finding an empty unit cell from among the plurality of unit cells by scanning the screen in a horizontal direction from an upper left corner; and
placing the existing image in the empty unit cell.

18. The image monitoring method of claim 15, further comprising:
receiving a command, input through the user interface, to enlarge a specific image from among a plurality of displayed images on the screen; and
based on receiving the command:
enlarging the specific image such as to cover at least one image from among the plurality of displayed images;
finding at least one empty unit cell in an order of priority by scanning the screen in a horizontal direction; and
placing, based on the order of priority, the at least one image that is covered in the at least one empty unit cell.

19. The image monitoring method of claim 15, further comprising:
receiving a command, input through the user interface, to enlarge a specific image from among a plurality of displayed images on the screen; and
based on receiving the command:
enlarging the specific image such as to cover at least one image from among the plurality of displayed images;
finding no empty unit cells by scanning the screen in a horizontal direction; and
placing, based on the finding no empty unit cells, the at least one image that is covered in empty unit cells obtained by expanding the plurality of unit cells.

20. The image monitoring method of claim 11, further comprising:
receiving a command, input through the user interface, to change a size or position of at least one from among displayed images on the screen;
changing and displaying the at least one from among displayed image according to the command; and,
displaying, based on a return command being input through the user interface, an entirety of each of the displayed images by auto-fitting the displayed images within the screen.
